(19) United States
(12) Patent Application Publication
(10) Pub. No.: US 2024/0123301 A1
(43) Pub. Date: Apr. 18, 2024

(54) SMART GOLF CART SYSTEM

(71) Applicant: Sj Tech Co., Ltd, Gangwon-do (KR)

(72) Inventors: Hwan Cheol HWANG, Hungerford (KR); Jae Hyeon JO, Gyeonggi-do (KR); Yeohosua KIM, Gyeonggi-do (KR)

(73) Assignee: Sj Tech Co., Ltd, Gangwon-do (KR)

(21) Appl. No.: 18/276,690

(22) PCT Filed: Jun. 21, 2022
(86) PCT No.: PCT/KR2022/008743

§ 371 Date: Aug. 10, 2023

(30) Foreign Application Priority Data
Nov. 30, 2021 (KR) 10-2021-0169458

(51) Int. Cl. A63B 55/60; A63B 71/06

(52) U.S. Cl. CPC A63B 55/61; A63B 71/0669; A63B 2225/20; A63B 2225/50

(57) ABSTRACT

The present invention is a smart golf cart system, which relates to a smart golf cart system comprising: a golf cart including a driving module and a wireless communication module, which are configured to move according to a preset signal, and configured to load a user's golf equipment; an RTK GNSS module providing GNSS information including location information of the golf cart through communication with the wireless communication module; a GIS module including a library part in which map information of a golf course is stored in advance, wherein the map information is in the form of GIS information including altitude information; and a path calculation module for calculating the path of the golf cart, wherein the path calculation module receives GNSS information of the golf cart through the RTK GNSS module to calculate an initial path, generates an avoidance path based on the GIS information of the initial path provided from the GIS module to form a reference path, and controls the driving module depending on the reference path.

### TECHNICAL FIELD

This application claims the benefit of priority based on Korean Patent Application No. 10-2021-0169458 dated Nov. 30, 2021, the disclosure of which is incorporated herein by reference in its entirety.

The present invention relates to a smart golf cart system capable of increasing user safety by considering, in calculating a path where a golf cart moves, GIS information, which is vertical location information (altitude information) together with GNSS information, which is horizontal location information.

### BACKGROUND ART

In game operation of a golf course, the rotation rate of the teams playing the game within a set time acts as an important factor. Since many users go around each hole of the golf course, the time distribution of the golf course is very important. Currently, the golf course uses a method that an operating staff (generally, referred to as a ‘caddy’) goes around each hole and allocates time. In this case, an operating staff must be assigned to each hole, so that the economic burden of hiring operating staffs is increased, and the method of deploying a small number of operating staffs and moving them to each hole has a disadvantage that a phenomenon of delaying the game occurs in the hole without any operating staff.

Recently, in the domestic golf world, no-caddy golf courses gradually increase due to the chronic shortage of caddies and the activation of public golf courses, and side effects such as game delay due to the absence of caddies constantly appear. Accordingly, many golf clubs increase the introduction of electrically driven robot carts, but there are almost no products from domestic companies, so that they are dependent on foreign products.

However, domestic fields are generally known to have harsher topographic conditions compared to fields such as the United States and the United Kingdom, which are leading the robot cart market, and really, because accidents such as unexpected overturning occur while using some foreign products, it is necessary to develop product suitable for domestic conditions.

The robot cart is an aggregation of various technologies ranging from the design of the body structure as well as balancing through fusion of attitude control technology sensors for robot traveling, steering technology, and the like, and driving safety technology and battery/motor technology, where the value and performance of the product cannot be mentioned only by simply listing the respective technologies, and at the time point when robot carts have just begun to appear, there is no reference suitable for the domestic environment, so that it is urgent to develop robot carts that are strong in the domestic field topography.

As a prior art, the ‘golf vehicle’ of Korean Patent Registration No. 10-0902943 is disclosed. The prior art discloses the golf vehicle to exchange information by performing wireless communication between golf vehicles located within a communication area without the need for a repeater, where it is meaningful in that it uses wireless communication equipment capable of GPS information and AD-Hoc.

However, as described above, if only GPS information is used in the domestic field with harsh topographic conditions, there is a high risk of the robot cart overturning, and it the robot cart overturns, it may cause great inconvenience due to damage to the golf equipment as well as safety accidents of users.
(Patent Document 1) Korean Patent Registration No. 10-0902943

### DISCLOSURE

### Technical Problem

The present invention has been devised to solve the above problems.

The present invention is intended to propose a technique for increasing user safety, in calculating a path where a golf cart moves, by considering not only GNSS information, which is horizontal location information, but also GIS information, which is vertical location information (altitude information), together.

In addition, when operating a golf game, it is intended to propose a technique for increasing the user's convenience by safely moving to a location adjacent to the user and assisting the user's golf game.

### Technical Solution

One example of the present invention for solving the above problems is a smart golf cart system, which provides a smart golf cart system comprising: a golf cart (100) including a driving module (110) and a wireless communication module (120), which are configured to move according to a preset signal, and configured to load a user's golf equipment; an RTK GNSS module (210) providing GNSS information including location information of the golf cart (100) through communication with the wireless communication module (120); a GIS module (230) including a library part (232) in which map information of a golf course is stored in advance, wherein the map information is in the form of GIS information including altitude information; and a path calculation module (250) for calculating the path of the golf cart (100), wherein the path calculation module (250) receives the GNSS information of the golf cart (100) through the RTK GNSS module (210) to calculate an initial path, generates an avoidance path based on the GIS information of the initial path provided from the GIS module (230) to form a reference path, and controls the driving module (110) depending on the reference path.

According to one example of the present invention, a user terminal (10) capable of communicating with the RTK GNSS module (210) may be provided on one side of the user.

According to one example of the present invention, the RTK GNSS module (210) may be configured to transmit location information of the user confirmed through the user terminal (10) to the path calculation module (250).

According to one example of the present invention, when the user's GNSS information is updated, the path calculation module (250) may control the drive module (110) according to a preset method to move the golf cart (100).

According to one example of the present invention, the path calculation module (250) may comprise a user location checking part (251) checking the user's GNSS information at a preset cycle; and a movement path generation part (252) checking the user's current location based on the user's GNSS information and generating a movement path to a location closest to the user's current location among the reference paths.

According to one example of the present invention, the user terminal (10) may comprise a movement calling part (11) requesting movement of the golf cart (100) to the user's current location; and a movement instructing part (12) requesting movement of the golf cart (100) to an arbitrary location set by the user.

According to one example of the present invention, the path calculation module (250) may further comprise a forced path generation part (253) checking GNSS information of a destination by the movement calling part (11) and the movement instructing part (12), and generating a forced path to the destination.

According to one example of the present invention, the forced path generation part (253) may be configured to control the driving module (110) by generating an avoidance path based on the GIS information of the forced path provided from the GIS module (230).

According to one example of the present invention, when at least two or more users share the golf cart (100), the path calculation module (250) may be configured to calculate the reference path and the movement path based on the user located farthest from the end destination of the golf course.

According to one example of the present invention, the golf cart (100) may further comprise: a display module (130) visually providing the map information of the golf course and the GNSS information of the user, and providing distance information to the end destination of the golf course; a camera module (140) configured to photograph the user's motion based on the user's GNSS information; and a score calculation module (150) automatically recognizing the user's swing motion based on the image information acquired from the camera module (140) to automatically calculate the user's score.

Meanwhile, the present invention provides a method of using the above-described smart golf cart system, wherein the method comprises steps of: (a) providing GNSS information including location information of the golf cart (100) through communication with the wireless communication module (120) in the RTK GNSS module (210) (S110); (b) storing map information of a golf course in the form of GIS information including altitude information in the GIS module (230) (S120); (c) receiving the GNSS information of the golf cart (100) to calculate an initial path, and then generating an avoidance path based on the GIS information on the initial path provided from the GIS module (230) to form a reference path in the path calculation module (250) (S130); and (d) controlling the driving module (110) depending on the reference path to move the golf cart (100) (S140).

### Advantageous Effects

The present invention can increase user safety by considering, in calculating a path where a golf cart moves, GIS information, which is vertical location information (altitude information) as well as GNSS information, which is horizontal location information, together.

In addition, when operating a golf game, it is possible to increase the user's convenience by safely moving to a location adjacent to the user and assisting the user's golf game.

### DESCRIPTION OF DRAWINGS

FIG. 1 is a conceptual diagram of the smart golf cart system according to the present invention.

FIG. 2 is a block diagram of the smart golf cart system according to the present invention.

FIG. 3 shows one example of a golf cart applied to the smart golf cart system according to the present invention.

FIG. 4 is a perspective view of one example of the golf cart shown in FIG. 3 viewed from another angle.

FIGS. 5(a) to 5(f) are schematic diagrams illustrating main functions of the smart golf cart system according to the present invention.

FIG. 6 is a schematic diagram schematically showing a process of processing the forced path generation part of the smart golf cart system according to the present invention.

FIG. 7 is a schematic diagram schematically showing a process in which a plurality of golf carts communicates with each other by grafting C-V2X technology to the smart golf cart system according to the present invention.

FIG. 8 is a flowchart of a method of using the smart golf cart system according to the present invention.

### MODE FOR INVENTION

Hereinafter, the ‘smart golf cart system’ will be described with reference to drawings.

In the present application, when a part is said to be “connected” to another part, this includes not only the case where it is “directly connected” but also the case where it is “electrically connected” with another element interposed therebetween. In addition, when a part is said to “comprise” a certain component, this means that it may further comprise other components without excluding other components, unless specifically described to the contrary, and it will be understood that it does not preclude the possibility of existence or addition of one or more other characteristics, or numbers, steps, operations, components, parts, or combinations thereof.

The term “step of (doing) ˜” or “step of ˜” as used herein does not mean “step for ˜”. In this application, the ‘part’ includes a unit realized by hardware, a unit realized by software, and a unit realized using both. Furthermore, one unit may be realized using two or more hardware, and two or more units may be realized by one hardware.

Also, the term ‘module’ means a unit that performs a predetermined function, but the module is not limited only to the function, and in addition to the function for which the module is specified, it is specified in advance that auxiliary functions and additional functions for performing the function may be further included, and may be recorded in one physical memory, or may be distributed and recorded between two or more memories and recording media.

In addition, various techniques described herein may be implemented together with hardware or software, or implemented together with a combination of both, where appropriate. As used herein, the terms such as ‘— part (unit)’, ‘— module’, ‘— server’ and ‘— system’ may likewise be treated as equivalents to computer-related entities, that is, hardware, a combination of hardware and software, software, or software in execution.

Some of the operations or functions described herein as being performed by a terminal, apparatus, or device may also be performed instead by a server connected to the terminal, apparatus, or device. Likewise, some of the operations or functions described as being performed by the server may also be performed by the terminal, apparatus, or device connected to the relevant server. Some of the operations or functions described herein as mapping or matching with the terminal may be interpreted as a meaning that performs mapping or matching the terminal's unique number or personal identification information, which is the terminal's identifying data.

As the system according to the present invention, all kinds of handheld-based wireless communication devices such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet) terminals, smartphones, smartpads, tablet PCs, and computing devices such as stationary PCs and notebooks may be used, and the distributed applications may be implemented in the form of computer programs, and may be recorded on readable and writable recording media and installed in the terminal.

In addition, the system according to the present invention is based on a network, where the network means a connection structure capable of exchanging information between nodes such as terminals and servers. An example of such a network includes a 3GPP (3rd Generation Partnership Project) network, a LTE (Long Term Evolution) network, a WIMAX (World Interoperability for Microwave Access) network, Internet, an LAN (Local Area Network), a Wireless LAN (Wireless Local Area Network), a WAN (Wide Area Network), a PAN (Personal Area Network), a Bluetooth network, a satellite broadcasting network, an analog broadcasting network, a DMB (Digital Multimedia Broadcasting) network, Wi-Fi, and the like, but is not limited thereto.

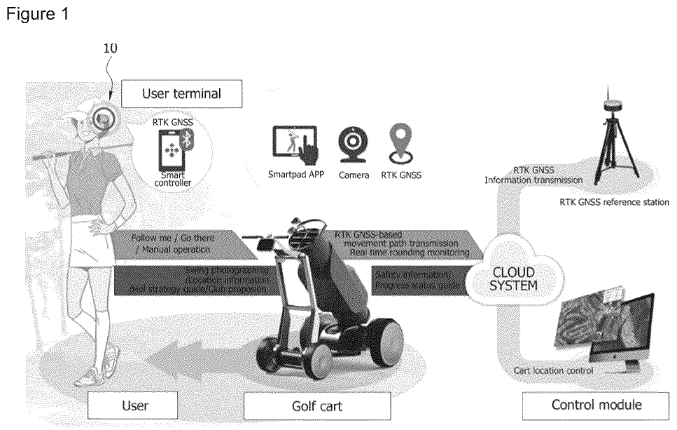

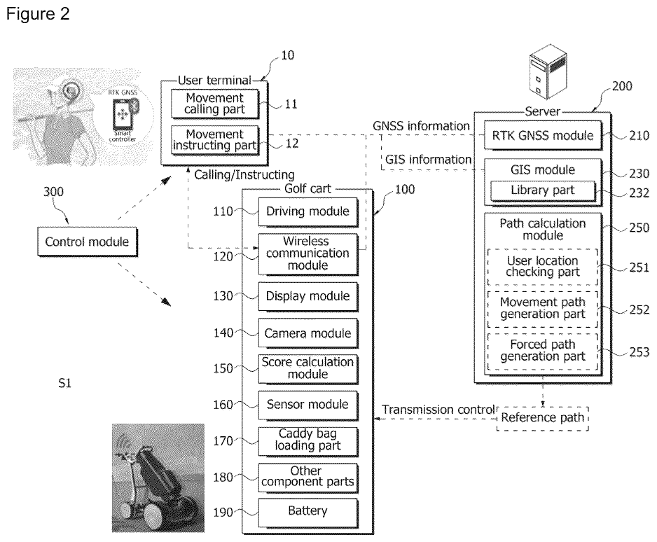

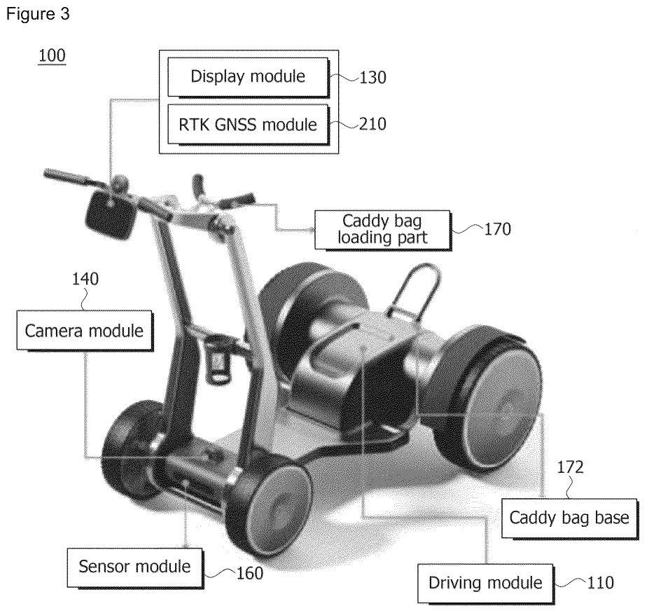

FIG. 1 is a conceptual diagram of the smart golf cart system according to the present invention, and FIG. 2 is a block diagram of the smart golf cart system according to the present invention. FIG. 3 shows one example of a golf cart applied to the smart golf cart system according to the present invention.

The smart golf cart system according to the present invention may basically be configured of a user terminal (10), a golf cart (100), and a server (200).

The user terminal (10) is a terminal attached to a part of the user's body to move together with the user in real time. FIG. 1 shows an example in which the user terminal (10) is coupled to one side of a hat worn by the user, but in addition to the hat of the user, any method is possible, if it is attached to a part of the user's body. The user terminal (10) may be referred to as a so-called ‘dongle’, which is configured to communicate with the wireless communication module (120) provided in the golf cart (100).

In addition, the user terminal (10) is configured to communicate with the RTK GNSS module (210) of the server (200). Through this, the user's location may be accurately determined.

The RTK GNSS module (210) means an ‘RTK (Real-Time Kinematic) GNSS (Global Navigation Satellite System)’, which is configure to check the user's location information (meaning GNSS information) through the user terminal (10). The specific configuration of the user terminal (10) will be described below.

The golf cart (100) is configured of a driving module (110), a wireless communication module (120), a display module (130), a camera module (140), a score calculation module (150), a sensor module (160), a caddy bag loading part (170), other component parts (180) and a battery (190).

The driving module (110) is a component controlled by the path calculation module (250), which is a component moving the golf cart (100). The golf cart (100) according to one example of the present invention is configured to operate electrically by including a battery (190), but includes all methods capable of driving the golf cart (100).

The wireless communication module (120) is configured to be capable of communicating with the server (200) and the user terminal (10). Here, the communication with the user terminal (10) may be connected in a low power Bluetooth (Bluetooth Low Energy, BLE) manner.

FIG. 7 is a schematic diagram schematically showing a process in which a plurality of golf carts communicates with each other by grafting C-V2X technology to the smart golf cart system according to the present invention.

Referring first to FIG. 7, the plurality of golf carts (100a, 100b, 100c) may be connected to the server (200) through a 5G wireless network. The golf cart (100) does not require relatively much data exchange. In the case of WAVE (Wireless Access for Vehicle Environment), RSUs (Roadside Units) need to be installed every few hundred meters. In the case of the RSU, it has a data exchange processing level comparable to that of a normal terminal, whereby the data exchange of the golf cart (100) may be operated smoothly without using the V2X (Vehicle to Everything) network technology. That is, in a non-emergency situation, even if a direct connection is made through the server (200), it can be sufficiently operated.

The display module (130) is configured so that the map information of the golf course and the GNSS information of the user are visually provided, and the distance information to the end destination of the golf course is provided. The display module (130) may be manipulated by a user, and may be configured as a touch panel for convenience of manipulation. The user may use the golf course information provided through the display module (130), and the display module (130) may provide the user with various information such as the distance to the hole, direction of the hole, wind speed, and weather.

Also, the display module (130) may suggest a strategy for each hole and a club based on the GIS information.

The camera module (140) is configured to photograph the user, and is based on the user's GNSS information, which is configured to rotate by finding the user according to the user's direction. The camera module (140) is configured to recognize a swing motion among user motions by being connected to an image processing module (not shown). Through this, it is configured to automatically calculate the user's score in conjunction with the score calculation module (150) while checking the swing.

The sensor module (160) may comprise both ultrasonic and infrared sensors, which is configured to sense obstacles in real time when the golf cart (100) moves by the operation of the driving module (110). Through the sensor module (160), it is possible to prevent the golf cart (100) from overturning or colliding with the obstacles.

The RTK GNSS module (210) is configured to provide GNSS information including location information of the golf cart (100) through communication with the wireless communication module (120). Here, the GNSS information can be regarded as meaning horizontal location information.

The GIS module (230) comprises a library part (232) in which map information of a golf course is stored in advance, where the map information is in the form of GIS information including altitude information. That is, the GIS information may comprise vertical location information.

Since the present invention comprises both GNSS information and GIS information, it considers the altitude information together when the golf cart (100) moves. Since it may be dangerous for the golf cart (100) to move in a place where the altitude information is too high or where the slope is relatively large, it is configured to calculate an avoidance path by identifying such a dangerous position through confirmation of the altitude information.

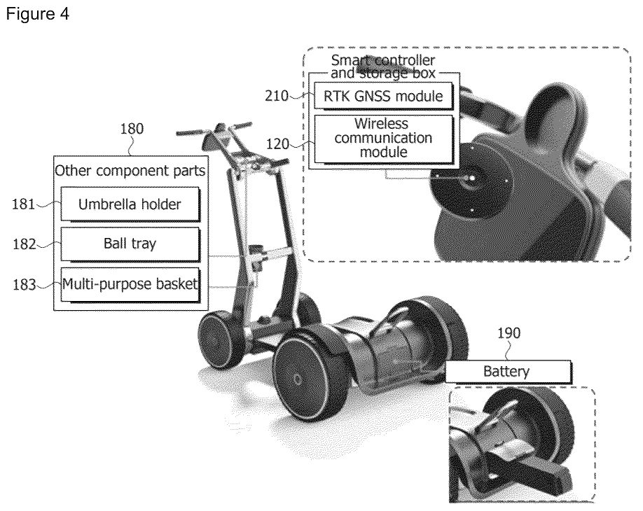

Meanwhile, FIG. 4 is a perspective view of one example of the golf cart shown in FIG. 3 viewed from another angle, and in FIG. 4, other component parts (180) including an umbrella holder (181), a ball tray (182) and a multi-purpose basket (183), and a battery (190), which is interchangeably mounted, are shown, which is one example, so that it may also be configured in other forms.

The path calculation module (250), which is a main component of the server (200), will be described.

The path calculation module (250) receives the GNSS information of the golf cart (100) through the RTK GNSS module (210) to calculates an initial path, and generates an avoidance path based on the GIS information of the initial path provided from the GIS module (230) to form a reference path, and is configured to control the driving module (110) according to the reference path.

That is, the initial path, the avoidance path, and the reference path are formed by the path calculation module (250). Here, the reference path means a basic path where the golf cart (100) travels. The golf cart (100) may also move along a cart traveling road located at the edge of each course, but may be traveled along the reference path located at a position that does not affect the golf game, in addition to the predefined cart traveling road.

As such, when at least two or more users share the golf cart (100), the path calculation module (250) is configured to calculate the reference path and the movement path based on the user located farthest from the end destination of the golf course, whereby it may not affect the golf game.

Specifically, the path calculation module (250) further comprises a user location checking part (251) and a movement path generation part (252).

The user location checking part (251) is configured to check the user's GNSS information at a preset cycle. The movement path generation part (252) is configured to check the user's current location based on the user's GNSS information, and to generate a movement path to a location most adjacent to the user's current location among reference paths.

That is, it moves along a preset reference path, but continuously moves to a location closest to the user's current location, whereby the user's convenience can be maximized.

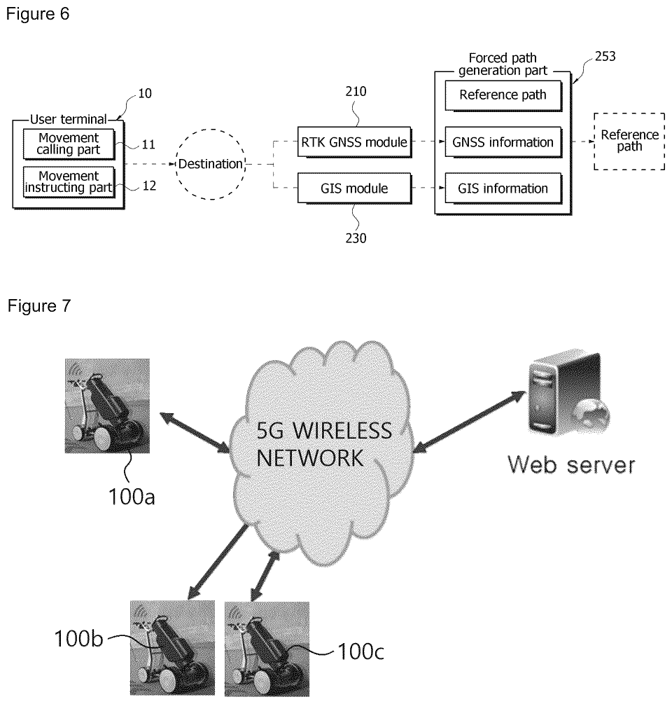

FIG. 6 is a schematic diagram schematically showing a process of processing the forced path generation part of the smart golf cart system according to the present invention. Referring to FIG. 6, a ‘follow me’ function and a ‘go there’ function performed through the user terminal (10) and the path calculation module (250) will be described.

The user terminal (10) comprises a movement calling part (11) and a movement instructing part (12). The parts are configured such that the movement calling part (11) requests the golf cart (100) to move to the user's current location, and the movement instructing part (12) requests the golf cart (100) to move to an arbitrary location set by the user. Here, the movement calling part (11) is associated with the ‘follow me’ function, and the movement instructing part (12) is associated with the ‘go there’ function.

To this end, the path calculation module (250) comprises a forced path generation part (253). The forced path generation part (253) is configured to check GNSS information of the destination by the movement calling part (11) and the movement instructing part (12), and to generate a forced path to the destination. The instruction by the movement calling part (11) and the movement instructing part (12) means a temporary or compulsory instruction.

That is, the golf cart (100) is operated according to the user's request signal. At this time, the forced path generation part (253) is configured to control the driving part (110) by generating an avoidance path based on the GIS information of the forced path provided from the GIS module (230).

In other words, for the safety of the golf cart (100), the forced path generation part (253) generates an avoidance path by considering all altitude information on the forced path, and by creating the avoidance path as such, it is possible to form the reference path that the golf cart (100) can travel without affecting the golf game.

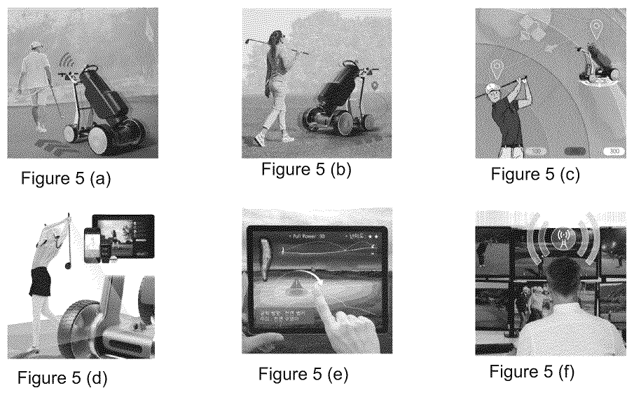

FIGS. 5(a) to 5(f) are schematic diagrams illustrating main functions of the smart golf cart system according to the present invention, and referring to FIG. 5, the main functions of the smart golf cart system according to the present invention will be described.

FIG. 5(a) means a user follow-up function through a precise positioning (RTK GNSS) method and Bluetooth. FIG. 5(b) is a function of autonomously moving to a specific location or next hole by forming a forced path based on GIS information. FIG. 5(c) provides real-time locations of a golf cart and a user through precise positioning (RTK GNSS). FIG. 5(d) is a function of photographing and confirming a swing image through a camera module. FIG. 5(e) is a function of proposing each hole strategy and a club through a display module based on GIS information. FIG. 5(f) is configured to notify a rounding dangerous area through a control module (300), and to guide golf game delays, and the like, which may be provided through an audio output part (not shown) provided in the display module (130).

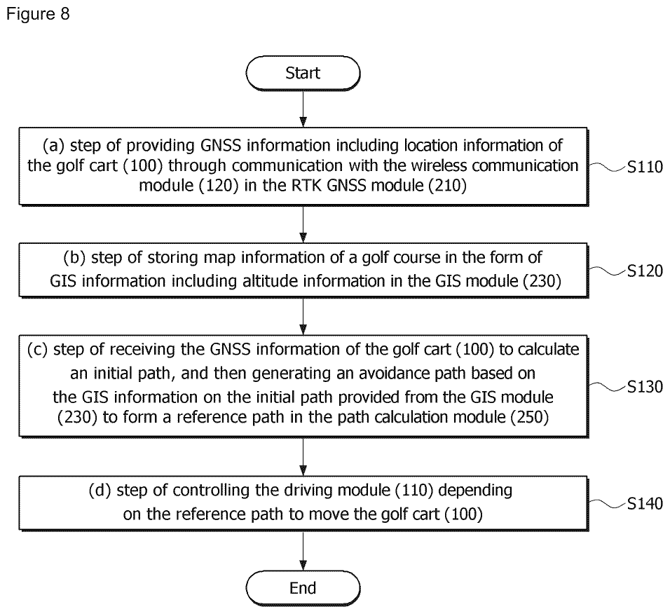

FIG. 8 is a flowchart of a method of using the smart golf cart system according to the present invention, and referring to FIG. 8, a method of using the smart golf cart system according to one example of the present invention will be described.

The method comprises steps (S110) to (S140).

The step (S110) is a step of providing, in the RTK GNSS module (210), GNSS information including location information of the golf cart (100) through communication with the wireless communication module (120).

The step (S120) is a step of storing, in the GIS module (230), map information of a golf course, but storing it in the form of GIS information including altitude information.

The step (S130) is a step of receiving, in the path calculation module (250), the GNSS information of the golf cart (100) to calculate an initial path, and then generating an avoidance path based on the GIS information on the initial path provided from the GIS module (230) to form a reference path.

The step (S140) is a step of controlling the driving part (110) depending on the reference path to move the golf cart (100).

Here, this specification has been described with reference to the examples shown in the drawings so that those skilled in the art can easily understand and reproduce the present invention, but these are only illustrative, and those skilled in the art will understand that various modified and equivalent examples can be made from the examples of the present invention. Therefore, the protection scope of the present invention should be defined by the claims.

1. A smart golf cart system comprising:
a golf cart including a driving module and a wireless communication module, which are configured to move according to a preset signal, and configured to load a user's golf equipment;
an RTK GNSS module providing GNSS information including location information of the golf cart through communication with the wireless communication module;
a GIS module including a library part in which map information of a golf course is stored in advance, wherein the map information is in the form of GIS information including altitude information; and
a path calculation module for calculating the path of the golf cart, wherein the path calculation module receives the GNSS information of the golf cart through the RTK GNSS module to calculate an initial path, generates an avoidance path based on the GIS information of the initial path provided from the GIS module to form a reference path, and controls the driving module depending on the reference path.

2. The smart golf cart system according to claim 1, wherein
a user terminal capable of communicating with the RTK GNSS module is provided on one side of the user,
the RTK GNSS module is configured to transmit location information of the user confirmed through the user terminal to the path calculation module, and
when the user's GNSS information is updated, the path calculation module controls the drive module (110) according to a preset method to move the golf cart.

3. The smart golf cart system according to claim 2, wherein the path calculation module comprises:
a user location checking part checking the user's GNSS information at a preset cycle; and
a movement path generation part checking the user's current location based on the user's GNSS information and generating a movement path to a location closest to the user's current location among the reference paths.

4. The smart golf cart system according to claim 3, wherein the user terminal comprises:
a movement calling part requesting movement of the golf cart to the user's current location; and
a movement instructing part requesting movement of the golf cart to an arbitrary location set by the user,
the path calculation module further comprises a forced path generation part checking GNSS information of a destination by the movement calling part and the movement instructing part, and generating a forced path to the destination, and
the forced path generation part is configured to control the driving module by generating an avoidance path based on the GIS information of the forced path provided from the GIS module.

5. The smart golf cart system according to claim 3, wherein
when at least two or more users share the golf cart,
the path calculation module is configured to calculate the reference path and the movement path based on the user located farthest from the end destination of the golf course.

6. The smart golf cart system according to claim 1, wherein
the golf cart further comprises:
a display module visually providing the map information of the golf course and the GNSS information of the user, and providing distance information to the end destination of the golf course;
a camera module configured to photograph the user's motion based on the user's GNSS information; and
a score calculation module automatically recognizing the user's swing motion based on the image information acquired from the camera module to automatically calculate the user's score.

7. A method of using the smart golf cart system according to claim 1, comprising steps of:
(a) providing GNSS information including location information of the golf cart through communication with the wireless communication module in the RTK GNSS module (S110);
(b) storing map information of a golf course in the form of GIS information including altitude information in the GIS module;
(c) receiving the GNSS information of the golf cart to calculate an initial path, and then generating an avoidance path based on the GIS information of the initial path provided from the GIS module to form a reference path in the path calculation module (S130); and
(d) controlling the driving module depending on the reference path to move the golf cart (S140).

8. A method of using the smart golf cart system according to claim 2, comprising steps of:
(a) providing GNSS information including location information of the golf cart through communication with the wireless communication module in the RTK GNSS module (S110);
(b) storing map information of a golf course in the form of GIS information including altitude information in the GIS module;
(c) receiving the GNSS information of the golf cart to calculate an initial path, and then generating an avoidance path based on the GIS information of the initial path provided from the GIS module to form a reference path in the path calculation module (S130); and
(d) controlling the driving module depending on the reference path to move the golf cart (S140).

9. A method of using the smart golf cart system according to claim 3, comprising steps of:
(a) providing GNSS information including location information of the golf cart through communication with the wireless communication module in the RTK GNSS module (S110);
(b) storing map information of a golf course in the form of GIS information including altitude information in the GIS module;
(c) receiving the GNSS information of the golf cart to calculate an initial path, and then generating an avoidance path based on the GIS information of the initial path provided from the GIS module to form a reference path in the path calculation module (S130); and
(d) controlling the driving module depending on the reference path to move the golf cart (S140).

10. A method of using the smart golf cart system according to claim 4, comprising steps of:
(a) providing GNSS information including location information of the golf cart through communication with the wireless communication module in the RTK GNSS module (S110);
(b) storing map information of a golf course in the form of GIS information including altitude information in the GIS module;
(c) receiving the GNSS information of the golf cart to calculate an initial path, and then generating an avoidance path based on the GIS information of the initial path provided from the GIS module to form a reference path in the path calculation module (S130); and
(d) controlling the driving module depending on the reference path to move the golf cart (S140).

11. A method of using the smart golf cart system according to claim 5, comprising steps of:
(a) providing GNSS information including location information of the golf cart through communication with the wireless communication module in the RTK GNSS module (S110);
(b) storing map information of a golf course in the form of GIS information including altitude information in the GIS module;
(c) receiving the GNSS information of the golf cart to calculate an initial path, and then generating an avoidance path based on the GIS information of the initial path provided from the GIS module to form a reference path in the path calculation module (S130); and
(d) controlling the driving module depending on the reference path to move the golf cart (S140).

12. A method of using the smart golf cart system according to claim 6, comprising steps of:
(a) providing GNSS information including location information of the golf cart through communication with the wireless communication module in the RTK GNSS module (S110);
(b) storing map information of a golf course in the form of GIS information including altitude information in the GIS module;
(c) receiving the GNSS information of the golf cart to calculate an initial path, and then generating an avoidance path based on the GIS information of the initial path provided from the GIS module to form a reference path in the path calculation module (S130); and
(d) controlling the driving module depending on the reference path to move the golf cart (S140).
